(19) United States
(12) Patent Application Publication
(10) Pub. No.: US 2011/0091130 A1
(43) Pub. Date: Apr. 21, 2011

(54) METHOD AND MODULE FOR IMPROVING IMAGE FIDELITY

(75) Inventors: Jocelyn Faubert, Montreal (CA); Remy Allard, Wentworth-Nord (CA)

(73) Assignee: UNIVERSITE DE MONTREAL, Montreal, QC (CA)

(21) Appl. No.: 12/992,712

(22) PCT Filed: Jun. 8, 2009
(86) PCT No.: PCT/CA2009/000814

§ 371 Date: Jan. 12, 2011

Related U.S. Application Data
(60) Provisional application No. 61/059,842, filed on Jun. 9, 2008.

(51) Int. Cl. G06K 9/40

(52) U.S. Cl. 382/275

(57) ABSTRACT

The present invention relates to a method and a module for improving image fidelity. For doing so, the present invention introduces noise (N) to at least one DAC value of at least some pixels, using one or multiple various patterns.

### FIELD OF THE INVENTION

The present invention relates to digital image fidelity, and more particularly to a method and module for improving image fidelity.

### BACKGROUND OF THE INVENTION

With the advent of virtual reality, gaming, High Definition Video, digital cameras and highly sensitive measurement apparatuses, the need for high definition displays has been consistently increasing. The trend in the industry has been mostly in changing televisions and monitors for newer models with higher number of pixels and/or higher number of bits.

The quality of a display is usually defined by the following criteria: spatial resolution, bit depth, contrast ratio, and temporal resolution.

Spatial resolution refers to the number of individual dots of color, known as pixels, contained in a display. Spatial resolution is generally represented using a number of horizontal pixels and a number of vertical pixels. Spatial resolution varies greatly, and more recent technologies are aiming at increasing available spatial resolution.

Bit depth corresponds to the number of bits used to describe a pixel. Higher bit depths allow for more numerous colors and resolution of luminance. To create the colors, three independent canons, each representing a primary color (red, green and blue), are added. In a 24-bit depth, the first 8 bits correspond to the red canon, the next 8 bits correspond to the green canon, and the last 8 bits refer to the blue canon. Each set of 8 bits corresponds to a value to be displayed for that respective canon. So, by adding their corresponding colors, the three canons provide 16,277,216 colors.

Contrast ratio refers to the difference in light intensity between white and black on a display. Usually the higher the contrast, the easier it is for a user to see details.

Temporal resolution relates to speed at which pixels can change color. With ever increasing spatial resolution, temporal resolution becomes an issue.

It is recognized that higher spatial resolution displays render more realistic and precise images. However, this realism and precision comes at a high price, both financially and environmentally. Furthermore, although the increased spatial resolution has improved overall perceived image quality, some users are still considering pixels definition noticeable, and for those reasons, for some applications, analog displays are still preferred over digital displays.

Various solutions have been developed to improve the image fidelity of displays. Some of those techniques rely on hardware: more powerful graphic cards, very high resolution or bit depth displays, and new standards. Others have approached this dilemma using a “soft” approach, i.e. developing software that improves the image fidelity, without increasing the spatial resolution or bit depth.

A first “soft” approach relies on a method named bit-stealing. The bit-stealing method, developed by Tyler and presented in an articled titled “Color bit-stealing to enhance the luminance resolution of digital displays on a single pixel basis”, in Proceedings of the IEEE, 76(1), 56-79, uses chromatic jitter to enhance luminance resolution. Instead of having one same Digital to Analog Converter (DAC) value for all three color guns, each gun is given slightly different DAC value. Having different DAC values for the three color guns enables greater resolution of luminance than when all three guns have the same DAC values. This modification alters the chromaticity of the pixels, while displaying greater luminance resolution. As the human eye is less sensitive to chromatic variations than luminance resolution, the chromatic jitter introduced is generally not detectable. Although this “soft” approach has proven to be useful in improving luminance resolution, its implementation is relatively complex and does not achieve a perceptually continuous image.

Another “soft” method relies on a process called dithering. Dithering, also known as half toning, has been described in a document titled “Digital half toning” by Ulichney, R. A. in Cambridge, Mass.: MIT Press 1987. Dithering is used to artificially display grayscale images using binary output devices. The dithering process uses spatial resolution to give the “illusion” of presenting grayscale images. For example, if in a given region half of the pixels are black and the others are white, the visual perception of that given region appears to be gray.

A simple dithering algorithm is called random dithering, as described in a publication titled “Dithering with blue noise” authored by Ulichney, R. A., published in the Proceedings of the IEEE, 76(1), 56-79. The random dithering algorithm compares the luminance intensity of each pixel of an original image with a cutoff criterion randomly selected from a uniform distribution for each pixel. If the pixel luminance intensity of the original image is greater than the cutoff criterion, the output pixel is white; otherwise the pixel is black. Although this algorithm has the advantage of being simple to implement, the fidelity of the displayed image is not appropriate for practical use. The difference between the original image and the displayed image corresponds to what is considered the noise introduced by the dithering algorithm.

Several algorithms have been developed to minimize the visual impact of the noise introduced by dithering. Such algorithms include the high pass noise also described in the publication titled “Dithering with blue noise” previously described, the ordered dithering algorithm introduced by Bayer in a publication titled “An optimum method for two level rendition of continuous tone pictures” published in the Conference Record of the IEEE International Conference on Communications, pp (26-11)-(26-15)), in New York, the error diffusion algorithm described by Floyd & Steinberg in “An adaptive algorithm for spatial grayscale”, published in the Proceedings of the Society for Information Display, 17 (2), pp. 75-77, and the contrast sensitivity algorithm developed by Mulligan and Ahumada and described in an article titled “Principled half toning based on human vision models”, published in Human Vision, Visual Processing, and Digital Display III, 1666, pp 109-121. These methods have all proven to give a better image fidelity than random dithering. However, their implementation is rather complex and requires additional computer resources.

Another way of overcoming noise introduced by dithering relies on the ordered dithering, described by Mulligan in “Digital half toning methods for selectively partitioning error into achromatic and chromatic channels”, published in Human Vision and Electronic Imaging: Models, Methods and Applications, 1249 in pages 261-270. In this method, the algorithm applies ordered dithering independently to each pixel by selecting between the two nearest luminance intensities displayable, instead of selecting between only two luminance intensities available.

This ordered dithering was implemented by Daly and Feng, and discussed in “Bit-depth extension: Overcoming LCD-driver limitations by using models of the equivalent input noise of the visual system”, published in Journal of the Society for Information Display, 13 (1), pages 51-66. Their implementation allowed enhanced apparent luminance intensity by combining techniques including contrast sensitivity. This combined method is rather complex, and its implementation impractical.

There is thus no simple solution for improving image fidelity of a digital display, and for providing digital displays with greater image fidelity. There is therefore a need for providing a method and module for improving image fidelity that is simple, efficient, and possible to use with all sorts of digital displays.

### SUMMARY OF THE INVENTION

The present invention provides a method and a module for improving digital image fidelity by introducing noise to a Digital to Analog Converter value of some of the pixels.

In accordance with another aspect, the present invention relates to a module for introducing noise to a Digital to Analog Converter value of some of the pixels, integrated in one of the following: a new piece of hardware, a software, a graphic card, a television, a mobile phone display, a display for an apparatus, a digital camera display, a module for reducing spatial resolution of images, or any other type of digital displays or modules improving image fidelity.

### BRIEF DESCRIPTION OF THE DRAWINGS

In the following description, the following drawings are used to describe and exemplify the present invention:

FIG. 1a-1c are graphical representation of different pixel patterns;

FIGS. 2 a-c are schematic representations of various aspects of the method of the present invention;

FIG. 3 is a schematic representation of a module of the present invention;

FIG. 4 is a graphical representation of an image on the right-hand side without the effect of the present invention, and on the left-hand side with the application of the method of the present invention; and

FIG. 5 are graphs representing contrast thresholds as a function of external noise contrast for two observers.

### DETAILED DESCRIPTION OF THE INVENTION

The present invention relates to a method and module for improving image fidelity of a display. More particularly, the present invention proposes a method and module, which introduce noise to a Digital to Analog Converter (DAC) value of at least some of the pixels, prior to their displaying. Additionally, the present invention is easy-to-implement, and conceptually consists of adding noise to a stimulus to be displayed on a digital display. From a certain aspect, the present invention generalizes random dithering to 2ⁿ luminance intensities, and as a resultant is equivalent to displaying continuous luminance intensities plus a certain amount of noise: it is perceptually equivalent to an analog display with a continuous luminance intensity resolution when the spatiotemporal resolution is high enough that the noise becomes perceptually negligible.

Displays, in the context of the present invention relates to any type of digital display adapted to show an image, such as televisions, computer monitors, monitors of scientific apparatuses, cell phone displays, digital camera displays, digital frames, iPODs™, etc.

Each display consists of an array of discrete pixels. The color and luminance intensity to be given to each pixel are dependent on three color canons, each representing a primary color (Red, Green, Blue). The color and luminance intensity of each pixel are dictated by 2ⁿ bits, where n represents ⅓ of the bit depth. Thus, for example, for a 24-bit depth display, 8 bits are for the red canon, 8 bits are for the green canon, and 8 bits are for the blue canon. The luminance intensity of each pixel is defined by a digital value, ranging in this particular example, between 0 and 255, which are also called digital-to-analog converter (DAC) values. The DAC translates each value into a voltage resulting into a given luminance for that particular canon for one pixel. Thus typically, each pixel is defined by the following equation:

pixel(x,y)=Red(r)Green(g)Blue(b)

As DAC values are not continuous, the continuous DAC values defining the stimulus (r for real value) must be rounded to the nearest integer (i for integer value typically ranging between 0 and 255) before being sent to the display, typically an equation like:

i=└r+0.5┐

This equation demonstrates that the displayed luminance intensities are rounded to the nearest DAC value. The rounding of DAC value results in a loss of information and discontinuities between pixels. Also, the obtained resolution of luminance is often too low to clearly appreciate contrast thresholds.

Method

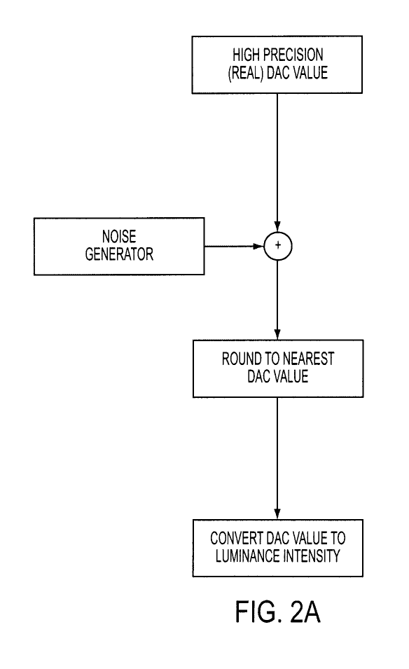

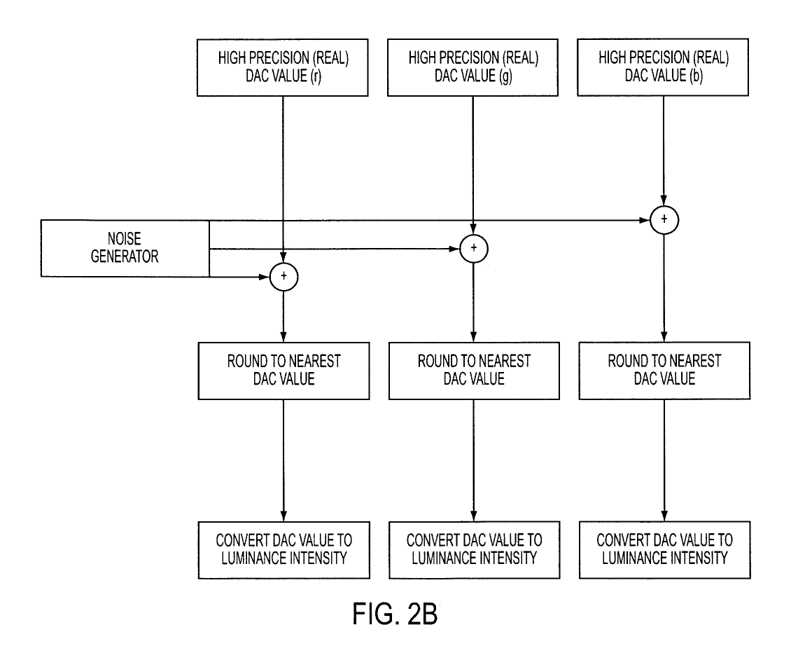

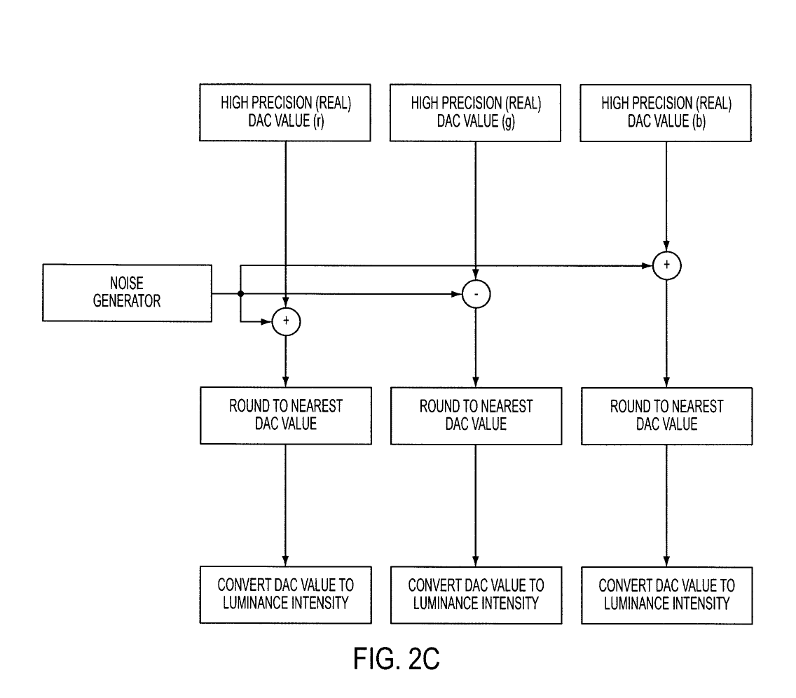

To overcome this problem, the present invention proposes a different methodology, hereinafter alternately called noisy-bit method, which includes introducing noise to a DAC value (or in the case of calibrated displays to at least one luminance intensity value) for at least some of the pixels, as shown on FIG. 2a.

As there are three color canons, the noise may be applied to only one, to a combination of, or to all three DAC values which correspond to the pixel, as depicted on FIGS. 2b and 2c. The noise may either consist of correlated noise, or uncorrelated noise. In accordance with a preferred embodiment of the present invention, the noise introduced is uncorrelated noise.

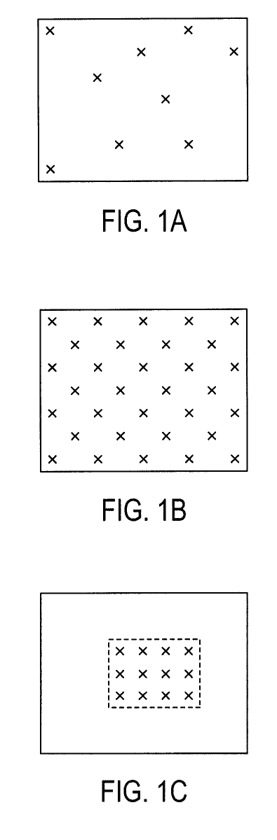

Depending on the display and system on which the present invention is to be implemented, various possibilities exist as to pixel pattern. For example, pixel patterns as shown on FIGS. 1a-1c could be applied. FIG. 1a shows a pixel pattern in which the noise is introduced randomly to pixels, while FIG. 1b depicts a regular pixel pattern. The present invention could also introduce noise only to a pre-selected area, as shown on FIG. 1c. It could alternately be possible and/or more interesting to introduce the noise to all pixels.

The noise can additionally be introduced in a static manner, i.e. in a pattern not varying over time, or dynamically, i.e. in a pattern varying in time. Depending on the temporal resolution of the display, it can also be interesting to introduce the noise not at every sweeping, but every other sweeping, or following a refresh rate that is sufficient to improve the fidelity of the displayed image, without too much processing effort.

Various ways can be used in the context of the present invention to introduce noise. One possible way is to introduce the noise randomly. Random noise can be introduced for example by randomly choosing between the two nearest DAC values. The probability distribution between the two values can be set so that the expected value is equal to the continuous DAC value defined by the stimulus function (r). Thus, the probability of choosing the higher DAC value would be equal to the remainder of the continuous DAC value. For example, if the continuous DAC value is 123.25, then the probability distribution would be 0.25 for 124 and 0.75 for 123 resulting into an expected value of 123.25. Consequently, the integer function (i) for the DAC value could replaced with the following equation:

$$i = \begin{matrix}[ \begin{matrix}r \\ r\end{matrix} ] & \begin{matrix}if R ( r ) \\ otherwise\end{matrix}\end{matrix}$$

where: —R(r) returns true with a probability equal to the remainder of r (i.e. r−└r┘) and false otherwise,
┌r┐ and └r┘ represent ceiling and floor functions respectively.

This method is equivalent to combining random dithering with the generalized application of dithering for 256 instead of 2 DAC values. Indeed, randomly selecting between the two nearest DAC values (└r┘ and ┌r┐) with a probability of choosing the highest DAC value (┌r┐) equal to the remainder of the DAC value (r−└r┘) is mathematically equivalent to rounding to one of the two nearest DAC values with a random cutoff criterion selected from a uniform distribution varying between the two nearest DAC values.

However, applied alone, this introduction of noise has experimentally resulted in increasing the error between the desired continuous (r) and the displayed (l) DAC value. Indeed, this introduction of noise chooses between the two nearest DAC values so that it occasionally selects a DAC value further than the nearest integer. As a result, the Root Mean Square error between the continuous DAC value and the DAC value sent to the display (l) will be greater using the present method than simply rounding to the nearest integer. This random selection results in an expected value that is equal to a desired continuous value (E(i)=r).

Alternately, the method of randomly introducing noise by selecting between two nearest DAC values is mathematically equivalent to rounding to the nearest DAC value after adding a noise value randomly selected from a uniform distribution varying between −0.5 and 0.5 DAC values (n). For instance, if the continuous DAC value (r) is 123.25, then randomly selecting a value between 122.75 and 125.75 and then rounding to the nearest integer results in a probability of selecting the DAC value 123 equal to 0.75 and a probability of selecting 124 equal to 0.25. Consequently, the method of the present invention can alternatively be implemented by adding a small amount of noise to the continuous DAC value (r), rather than by explicitly implementing the random selection between the two nearest DAC values. So the addition of noise to the continuous DAC value (r) as previously suggested by the method of the present invention, improves the image fidelity by rendering the image displayed more continuous.

Although the previous equations have been provided for DAC values of 8 bits, it is apparent to those skilled in the art that those equations can be generalized by replacing the value 255 by 2⁽ⁿ⁻¹⁾ throughout, where n represents the number of bits supported by the DACs of the display.

After the introduction of noise, the method of the present invention may further reduce the luminance intensity of the pixel after introduction of the noise. The reduction of the luminance intensity may be optional, depending on the methodology used to introduce the noise. The reduction of the luminance intensity may be performed before rounding the desired real value to the nearest DAC value level (integer).

Thus by introducing noise to the DAC value at the pixel level, it is possible to improve the luminance resolution of displays and render displayed images with greater fidelity.

Module

In another aspect, the present invention relates to a module for improving digital image fidelity. The module may be integrated as a new piece of hardware, a software, a component or function of a graphic card, a television, a mobile phone display, a game console, a video game, a display for an apparatus, a digital camera display, a module or software for reducing spatial resolution of high definition and or very high definition images, or any other type of digital displays or modules aiming at improving image fidelity.

The module 200, shown on FIG. 2 includes a noise generator 210, and may optionally include a DAC value reducer 250. The noise generator 210 introduces the noise to the DAC value of the pixels as previously described. The noise can be thus be introduced to one or several of the DAC values of the pixel, and may be introduced to some or all of the pixels, depending on the desired application. For doing so, the noise generator 210 includes an noise generator 220, a DAC value selector 230 and a pixel pattern definition sub-module 240. The DAC value selector 230 determines whether the noise is to be introduced to one or several DAC values for each of the pixel to which noise is introduced. The pixel pattern definition sub-module 240 determines the pattern of noise to be applied. For example, the pixel pattern definition sub-module 240 may provide selections to a user, which would correspond to various patterns, and ask a user of the display in which the module is incorporated, to select a pattern, for improving image fidelity. Many pixel patterns could thus be proposed as discussed previously, and selected from. Alternately, the pixel pattern definition sub-module 240 could alternately relate to a select function performed by a user of a software, for adding noise to a selected area of an image to be displayed.

The module 200 may further include a DAC value reducer 250, which is adapted for reducing the DAC value of the pixels after the introduction of noise. The module 200 may additionally include an image fidelity compression module 260, which is adapted for receiving higher definition images, calculating for each lower definition pixel a real value representative of the compressed data, prior to introducing noise thereto by the noise generator. As the noise is introduced on the real value, the overall result is a lower definition image with better fidelity than with traditional compression methods and tools.

The module 200 could alternately be implemented within an apparatus comprising a display, such as a computer display, a digital television, a mobile phone display, or any other type of digital display. For doing so, the module 200 could be included in the form of hardware, included between the graphical card and the display, or as an electronic adaptor which is connected at an input of a display and through which the input signal is received, and noise added prior to being fed into the input of the display. The module 200 could also consist of software that is added to any other existing graphical software tool, so as to render better image fidelity for any type of images to be displayed on digital displays.

The method and module of the present invention could further be very interesting in applications related to reduction of spatial resolution. When an image of higher spatial definition is to be displayed on a display with lower spatial definition, it would be advantageous to apply the present method of introducing noise, prior to sending the image to the display with lower spatial definition. As the reduction of spatial definition creates an image with increased color definition because of the averaging of bit-depth values of several pixels into one bit-depth for one pixel, the averaged bit-depth is usually more likely not an integer value. Prior to rounding this value to the closest integer as known in the art, it is very advantageous to take advantage of the real value obtained, and add noise as thought in the present invention. The addition of noise increases the image fidelity, and thus takes advantage of some of the real value, rather than simply rounding up the value to the closest DAC value, and disregarding the non-integer value.

It could further be advantageous in the context of the present invention, to further consider balancing the overall luminance of a pixel, by correlating the noise introduced on one or two color canons, and adjusting the third canon to ensure constancy of the overall luminance level, to which human eye is more sensitive than chromatography. For doing so, the present invention could further include balancing the noise introduced in the first and second color canons, by adjusting the DAC value of the third canon so as to maintain an overall luminance level as without the introduction of noise for that pixel. Such a balancing could thus be performed in the DAC value reducer 350.

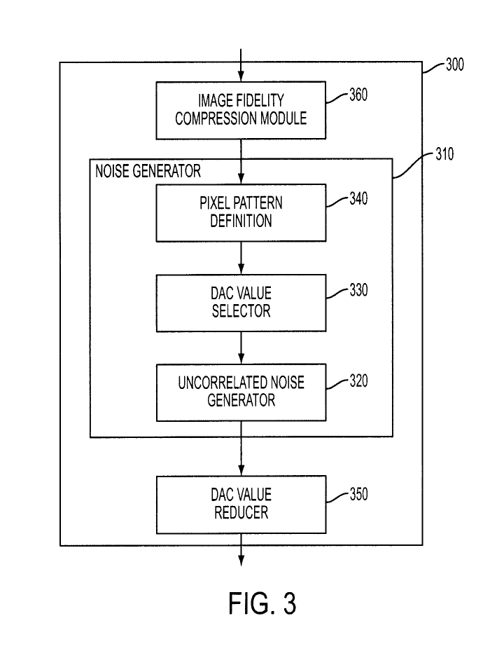

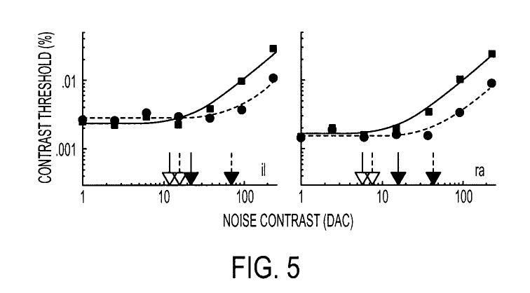

Reference is now made to FIG. 3, which depicts a graphical representation of an image on the left-hand side with the effect of the present invention, and on the right-hand side without the application of the present invention. The top row represents the original image (also called stimulus), displayed using a precision of 1 DAC value, which is a sine wave grating varying between the DAC values 64 to 196. The second row represents the same stimulus displayed using a lower intensity resolution, that is, only the DAC values 64, 128 and 196 being used. On the left, the noisy-bit method is implemented (rounding to the nearest of the three DAC values after adding noise uniformly varying between −32 and +32) and on the right the values are simply rounded to the nearest of the three DAC values. For each subsequent row, the contrast of the sine wave grating is divided by a factor of two and the intensity resolution is increased by a factor of 2. As a result, at the lower row the sine wave grating varies between 127 and 129 DAC values and the DAC values used to represent the grating are 127, 128 and 129. FIG. 5 does clearly demonstrate that the addition of noise renders an image with greater fidelity, than with the traditional method of rounding to the nearest DAC value.

Although the present invention is presented in the context of combination of DAC values for three canons, the present invention is not limited to such technology, is equally applicable to displays using any number of canons, various spatial and temporal resolutions, and unlimited bit-depth.

Experimental Results

The objective of the experiment was to evaluate whether a spatiotemporal resolution of a typical digital display (60 Hz and 1024×768 pixels) is great enough to measure contrast thresholds using the noisy-bit method. As mentioned above, the noisy-bit method may be implemented by adding noise to the DAC value(s) with a uniform distribution ranging between ±0.5 DAC values. In the context of the present invention, the noise contrast is defined by the range covered by the uniform distribution, which can be represented in luminance intensity (for calibrated displays) or DAC values. Using the noisy-bit method, the noise contrast added to the stimulus function (image to be displayed) is 1 DAC value.

To assess if the noise introduced within the displayed stimulus by the noisy-bit method affects the contrast threshold, the contrast threshold of a given stimulus was evaluated as a function of the noise contrast. If the noise is a limiting factor, than increasing the noise contrast should affect the contrast threshold by the same proportion (slope of 1 on the TvC function). Alternatively, if the observer's internal noise is greater than the external noise (i.e. the noise introduced by the noisy-bit method), then increasing the external noise will not affect contrast threshold (slope of 0 on the TvC function).

### Experiment #1

Two observers participated in the study. One of them was aware of the purpose of the experiment and one of the inventors, and the other was naïve to the purpose of the experiment. Both had normal or corrected-to-normal vision.

The stimuli were presented on a 19 in ViewSonic E90FB .25 CRT monitor powered by a Pentium 4 computer combined with a Matrox Parhelia512 graphic card. All three-color guns were constrained to have the same DAC value. As a result, this setup could display 256 different luminance intensities (8-bit luminance depth). The greatest luminance intensity attainable was 94 cd/m². The display was gamma corrected using a Minolta CS100 photometer interfaced with a homemade program to produce a linear relationship between the DAC value and the luminance intensity. The refresh rate was set to 60 Hz, which is typically the lowest refresh rate for most computers. The screen resolution was set to the most standard screen resolution of 1024×768 pixels covering an area of 32×24 cm. At the viewing distance of 114 cm, the width and height of each pixel were 1/64 deg of visual angle. In other words, the spatial resolution of the displayed stimulus was 64 pixels/deg. The monitor was the only light source in the room.

To measure contrast thresholds, sine wave gratings are the most widely used stimuli:

r(x,y,t)=128+c sin(fx+p)

where c corresponds to the stimulus Michelson contrast and was the dependent variable. f corresponds to the spatial frequency, which was fixed to 4 cpd (approximately the spatial frequency to which humans are the most sensitive). And p represents the phase, which was randomized at each presentation. Notice that the luminance of the grating only depended on the horizontal position (x) and not on the vertical position (y) or the time (t). Consequently, the grating was vertically orientated and static.

To implement the noisy-bit method, noise must be added to the stimulus function:

r′(x,y,t)=r(x,y,t)+nₑₓₜN(x,y,t)

where nₑₓₜ represents the noise contrast. As mentioned above, for the noisy-bit method in the context of the present experiment, the contrast of the noise is fixed to 1 DAC value. However, in the present experiment the noise contrast was varied so that nₑₓₜ varied between 1 and 230 DAC values using 7 different noise contrasts.

For static stimuli, adding dynamic noise implies passing from a static presentation (an image) to a dynamic presentation composed of several images. A dynamic presentation consumes more computer resources (memory, processing time, etc) than a static presentation, which only requires the rendering of a single image. Consequently, passing from static to a dynamic presentation may not always be convenient and may thereby limit the application of the noisy-bit method. However, the noisy-bit method may also be applied using static noise. That is, the noise template added to the stimulus would not vary over time (N(x,y) instead of N(x,y,t)) so that the exact same image would be presented in all frames. For such application, only the spatial summation would permit the integration of the different pixels. If the spatial resolution is high enough, the noise introduced by the noisy-bit method should not affect contrast thresholds. To evaluate if only the spatial resolution could permit the application of the noisy-bit method, the method of the present invention was experimented both spatially (static noise) and spatiotemporally (dynamic noise).

To minimize contrast thresholds, a relatively large spatiotemporal window was used. The presentation time of the stimulus was 500 ms and the spatial window was a disk with a diameter of 2 degrees of visual angle with a soft edge defined by a half cosine of 0.5 degrees.

A two alternative-interval-forced-choice task was used, which consisted in identifying the interval in which the sine wave was present by pressing one of two keys. Both intervals contained the same noise contrast (nₑₓₜ) but were generated by two distinct noise samplings. The delay between the two intervals was 500 ms. Between stimuli presentations, the screen remained blank at the mean luminance level (L₁₂₈) and a fixation point was presented.

The contrast (c) of the grating in the interval in which the sine wave was presented was manipulated by a 2-down-1-up staircase procedure, as discussed in “Transformed up-down methods in psychoacoustics” by Levitt, H. in the Journal of the Acoustical Society of America, 49 (2), Suppl 2:467+. In the other interval, the contrast (c) was set to 0. The staircase was interrupted after 10 inversions and the threshold was evaluated as the geometric mean of the last 4 inversions. The step size was fixed to 0.05 log units and the initial contrast (c) was always set well above threshold.

Overall, there were 14 different noise conditions: 7 noise contrasts and the noise was either static or dynamic. These 14 conditions were evaluated 3 times each resulting into 42 staircases performed in a pseudorandom order. For each of these 14 conditions, the resulting threshold was estimated as the geometric mean of the 3 staircases.

The internal equivalent noise measured was 22 and 16 DAC values in the static noise condition and 71 and 44 DAC values in the dynamic noise condition. As a result, the detection thresholds using the noisy-bit method (conditions when the noise contrast was 1 DAC value) indicated that the noise introduced by the noisy-bit method was considerably smaller than the observer's internal noise. Hence, it was possible to significantly increase the external noise contrast without affecting contrast threshold. It was therefore concluded that the noise introduced by the noisy-bit method (noise contrast of 1 DAC value) did not affect contrast thresholds either in the static or in the dynamic condition.

As mentioned above, applying the noisy-bit method is equivalent to having a noisy continuous grayscale display. Using this method, the noise corresponds to the luminance variation introduced by randomly selecting between the two nearest DAC values, which corresponded to the conditions when the external noise contrast was 1 DAC value. The present experiment showed that this noise had no significant impact. The noisy-bit method enabled a 256 grayscale resolution apparatus to be perceptually equivalent to a continuous (i.e. infinite) grayscale resolution.

### Experiment #2

The previous experiment showed that the noise introduced by the noisy-bit method did not significantly affect the contrast threshold of a given task. However, this does not imply that the noise was not detectable. A given noise contrast could be perceived without affecting contrast threshold. This would result into a qualitative difference between a continuous grayscale display and discrete grayscale display combined with the noisy-bit method. The objective of the second experiment was to show that the noise introduced by the noisy-bit method was not perceived even for relatively low spatiotemporal screen resolutions. If the noise is not perceptible, not only would the noisy-bit method enable contrast threshold measurements equivalent to continuous displays, it would also be qualitatively (or perceptively) equivalent. Indeed, the difference between a continuous display and 256 grayscale display would not be measurable nor perceptible.

The same apparatus was used as in the previous experiment and the same two observers participated to the study. The stimuli were composed of noise:

r(x,y,t)=128+nₑₓₜN(x,y,t)

The noise detection task consisted in a two-interval-forced-choice procedure. One interval was blanked (nₑₓₜ=0, that is an even gray) and the other contained noise. A 2-down-1-up staircase procedure as described in the previous experiment was used to measure the noise contrast threshold (nₑₓₜ). Each threshold was evaluated 3 times in static and dynamic noise conditions resulting in 6 staircases.

The noise contrast thresholds were 12 and 5.9 DAC values in the static noise condition and 16 and 7.6 DAC values in the dynamic noise condition. Below these noise contrasts the observers were unable to differentiate between even gray and noise. Consequently, the noise introduced by the noisy-bit method (1 DAC value) was not perceptible. We therefore conclude that there was no qualitative or perceptible difference between a digital 8-bit grayscale display using the noisy-bit method and an analog display able to display an infinite number of grays. Note that this was true even when using a relatively low spatiotemporal resolution (0 Hz (i.e. static) and 64 pixels/deg) for present-day computers.

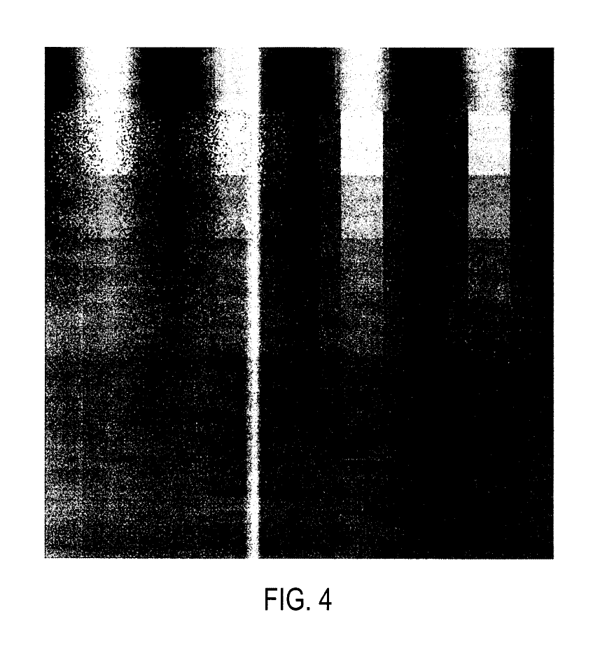

A better understanding of the results of Experiments 1 and 2 can be obtained by reviewing the graphs of FIG. 4. These graphs represent the contrast thresholds as a function of the external noise contrast for each observer. Squares and circles correspond to thresholds when the noise was static and dynamic respectively. The solid and dashed lines show the best fit. The filled arrows illustrate the internal equivalent noise. Empty arrows illustrate the noise contrast threshold in static (solid) and dynamic (dashed) conditions.

The noisy-bit method introduces low contrast noise to enhance the luminance intensity precision of digital displays. This method is equivalent to displaying colors with a continuous precision and adding noise to the displayed image. The two experiments showed that the low contrast noise introduced by the noisy-bit method does not affect contrast threshold and is not perceptible. Thus, when the spatiotemporal resolution is high enough (which is easily attainable with typical computers), a discrete 8-bit display combined with the noisy-bit method is perceptually equivalent to an analog display having a continuous precision.

The present invention has been described by way of preferred embodiments. It should be clear to those skilled in the art that the described preferred embodiments are for exemplary purposes only, and should not be interpreted to limit the scope of the present invention. The method and module as described in the description of preferred embodiments can be modified without departing from the scope of the present invention. The scope of the present invention should be defined by reference to the appended claims, which clearly delimit the protection sought.

1. A method for improving image fidelity of a digital display, the method comprising:
adding noise in a generalized 256 luminance intensities random dithering to a stimulus to be displayed,
whereby the stimulus and added noise results in displaying continuous luminance intensities plus a certain amount of noise rendering the digital display perceptually equivalent to an analog display with a continuous luminance intensity resolution.

2. A method for improving image fidelity, the method comprising:
introducing uncorrelated noise (N) to at least one Digital to Analog Converter (DAC) value of at least some pixels.

3. The method of claim 2, wherein the noise (N) is introduced on all three DAC values corresponding to each of the at least some pixels.

4. The method of claim 2, wherein the noise is introduced to pixels in accordance with one of the following patterns: to pixels selected randomly, to a pattern of pixels, to pixels of a selected area, or to all pixels.

5. The method of claim 2, wherein the noise is introduced randomly.

6. The method of claim 5, wherein the noise is introduced in one of the following patterns: statically, or temporally.

7. The method of claim 5, wherein the noise N is introduced using the following equation:
r′(x,y,t)=r(x,y,t)+N(x,y,t)

8. The method of claim 5, wherein the random introduction of noise follows a probability distribution between the two adjacent DAC values

9. The method of claim 5, wherein the noise is introduced randomly and is selected from a uniform distribution varying between (−0.5 and 0.5)*2ⁿ DAC value.

10. The method of claim 2, further including reducing the DAC value of the pixel after introduction of the noise.

11. A module for improving image fidelity, the module comprising:
a noise generator for introducing noise (N) to at least one DAC value of at least some pixels of an image.

12. The module of claim 11, wherein the noise is introduced to the pixels in accordance with one of the following patterns: to randomly selected pixels, to a predefined pattern of pixels, to pixels corresponding to a pre-selected area, or to all pixels.

13. The module of claim 11, wherein the noise (N) is introduced on all three DAC values corresponding to each of the at least some pixels.

14. The module of claim 11, wherein the noise is introduced randomly.

15. The module of claim 14, wherein the noise is introduced in one of the following patterns: statically or temporally.

16. The module of claim 11, further comprising a DAC value reducer for reducing the DAC value of the at least some pixels after the introduction of noise (N).

17. The module of claim 11, integrated in one of the following: a new piece of hardware, a software, a graphic card, a television, a mobile phone display, a display for an apparatus, a digital camera display, a module for reducing spatial resolution of images, or any other type of digital displays or modules improving image fidelity.
